(19) United States
(12) Patent Application Publication
(10) Pub. No.: US 2019/0141975 A1
(43) Pub. Date: May 16, 2019

(54) BAIT HOLDER WITH HOOK

(71) Applicants: Raymond Quiles, Old Bridge, NJ (US); Joseph Ognibene, Howard Beach, NY (US)

(72) Inventors: Raymond Quiles, Old Bridge, NJ (US); Joseph Ognibene, Howard Beach, NY (US)

(21) Appl. No.: 15/809,322

(22) Filed: Nov. 10, 2017

(51) Int. Cl. A01K 97/04; A01K 83/06; A01K 99/00

(52) U.S. Cl. CPC A01K 97/045; A01K 99/00; A01K 83/06

(57) ABSTRACT

An apparatus including a body portion, having an inner chamber inside the body portion, wherein the body portion has a first end, and an opposing second end. The apparatus may also include a loop located outside of the body portion, and connected to the body portion; and a plurality of holes in the body portion, which lead to the inner chamber. The body portion may have a region including a first wall and a second wall, wherein the first wall abuts against and is in contact with the second wall in a rest state, and wherein when a prying force is applied, the first wall can be separated from the second wall, so that there is a space between at least part of the first wall and at least part of the second wall, so that an item can be inserted through the space and into the inner chamber of the body portion.

### FIELD OF THE INVENTION

This invention relates to fishing devices.

### BACKGROUND OF THE INVENTION

There are various known devices, such as hooks, lures, and other devices for catching fish.

### SUMMARY OF THE INVENTION

In at least one embodiment, an apparatus is provided comprising a body portion, having an inner chamber inside the body portion, wherein the body portion has a first end, and an opposing second end. The apparatus may also include a loop located outside of the body portion, and connected to the body portion; and a plurality of holes in the body portion, which lead to the inner chamber. The body portion may have a region including a first wall and a second wall, wherein the first wall abuts against and is in contact with the second wall in a rest state, and wherein when a prying force is applied, the first wall can be separated from the second wall, so that there is a space between at least part of the first wall and at least part of the second wall, so that an item can be inserted through the space and into the inner chamber of the body portion. The body portion may be made of rubber, or some other flexible material.

The apparatus may include a first hook fixed to the body portion nearer the second end than the first end, wherein the loop is located nearer the first end than the second end. The apparatus may include a second hook fixed to the body portion nearer the second end than the first end, and spaced apart from the first hook. The space may be larger than any of the plurality of holes.

In at least one embodiment, a method is provided comprising applying a prying force to a region of a body portion of an apparatus to create a space between a first wall of the body portion and a second wall of a body portion; and inserting fishing bait through the space and into an inner chamber of the apparatus; wherein the apparatus is comprised of: the body portion, having the inner chamber inside the body portion, wherein the body portion has a first end, and an opposing second end; a loop located outside of the body portion, and connected to the body portion; and a plurality of holes in the body portion, which lead to the inner chamber. The method may further include connecting the loop to a fishing line; and casting the body portion into a body of water with the loop connected to a fishing line.

### BRIEF DESCRIPTION OF THE DRAWINGS

FIG. 1 shows a right, front, and top perspective view of a bait holder with hook in accordance with an embodiment of the present invention;

FIG. 2 shows an elevational front view of the bait holder with hook of FIG. 1;

FIG. 3 shows an elevational rear view of the bait holder with hook of FIG. 1;

FIG. 4 shows an elevational right side view of the bait holder with hook of FIG. 1;

FIG. 5 shows an elevational left side view of the bait holder with hook of FIG. 1;

FIG. 6 shows an elevational top view of the bait holder with hook of FIG. 1;

FIG. 7 shows an elevational bottom view of the bait holder with hook of FIG. 1;

FIG. 8 shows the bait holder with hook of FIG. 1, in a first state, and held by two hands;

FIG. 9 shows the bait holder with hook of FIG. 1, in a second state, and held by two hands;

FIG. 10 shows the bait holder with hook of FIG. 1, in the second state, and held by one hand;

FIG. 11 shows the bait holder with hook of FIG. 1, in the second state, held by one hand, and with a second hand shown inserting a piece of bait, such as a small fish or a worm;

FIG. 12 shows the bait holder with hook of FIG. 1 attached to a fishing line of a fishing device, with the bait holder and hook shown in a body of water in which a fish is swimming; and

FIG. 13 shows the fishing line of the fishing device, and the fish of FIG. 12, after the bait holder and hook has been swallowed by the fish of FIG. 12.

### DETAILED DESCRIPTION OF THE DRAWINGS

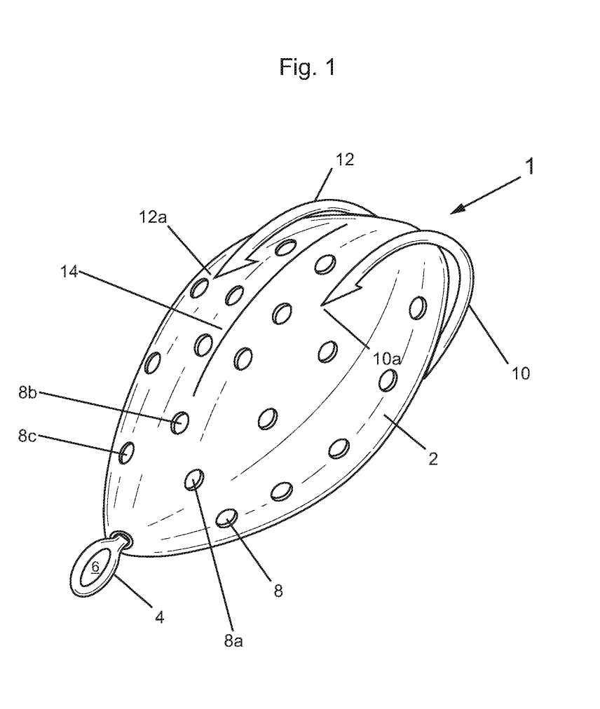

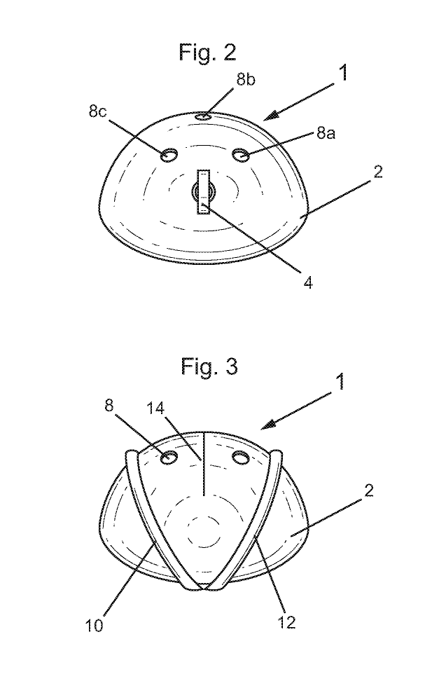

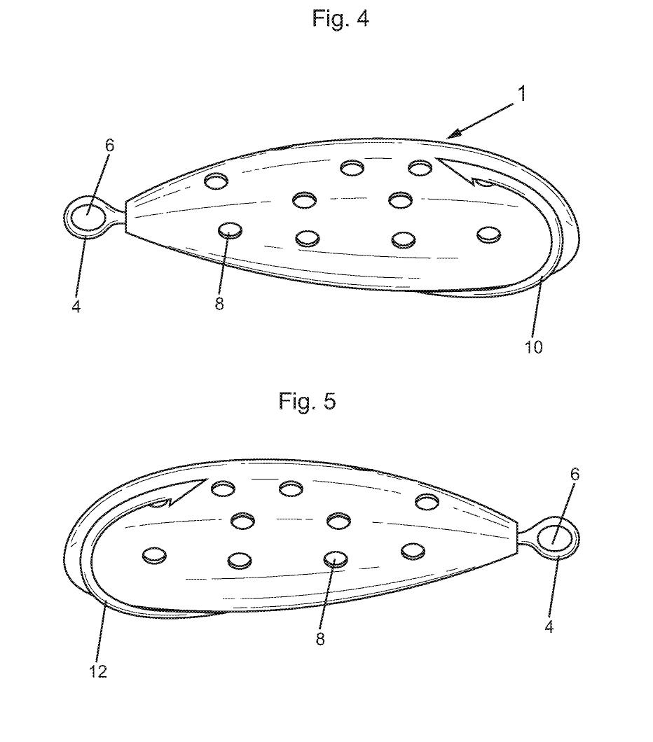

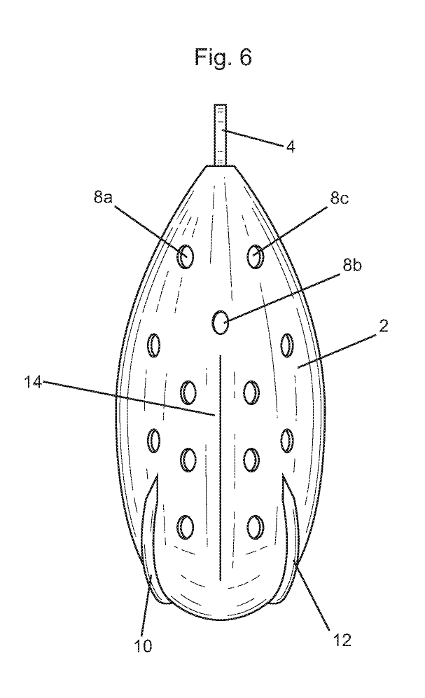

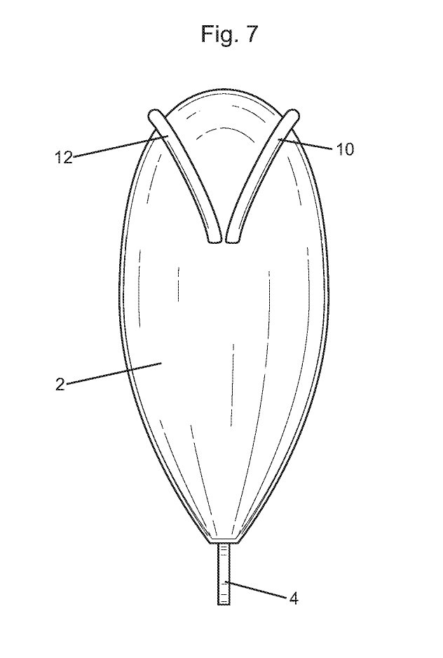

FIG. 1 shows a right, front, and top perspective view of a bait holder with hook 1 in accordance with an embodiment of the present invention. FIGS. 2-7 show elevational rear, right side, left side, top, and bottom views. respectively, of the bait holder with hook 1 of FIG. 1.

Referring to FIGS. 1-7, the bait holder with hook 1 includes a body portion 2, a loop 4 connected to the body portion 2, an opening 6 in the loop 4, a plurality of openings 8 in the body portion 2, hooks 10 and 12 attached to the body portion 2, and a section 14 for inserting bait into a chamber 14c shown in FIGS. 9-11. The plurality of openings 8 include openings 8a, 8b, and 8c which lead to chamber 2a inside of the body portion 2.

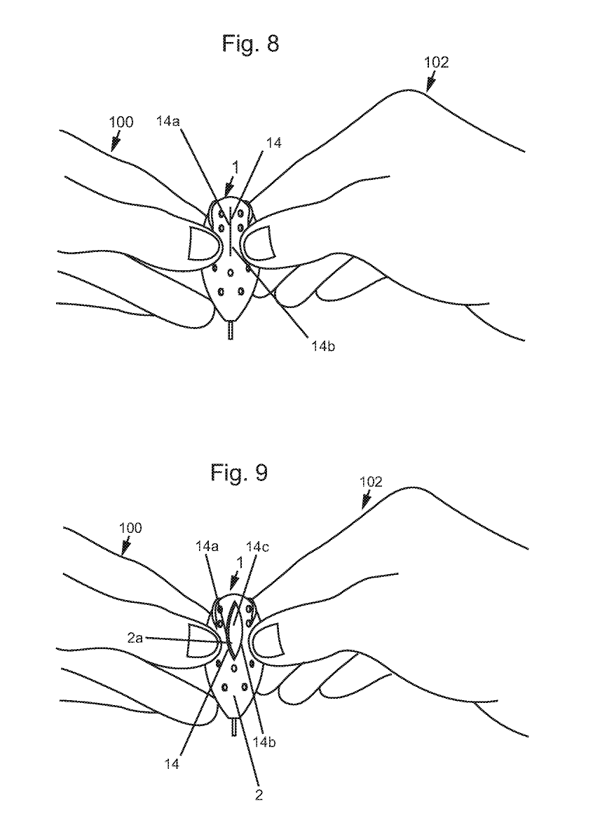

FIG. 8 shows the bait holder with hook 1 of FIG. 1, in a first state, and held by hands 100 and 102. In the first state the section 14 is closed so that wall or side 14a abuts and/or contacts side or wall 14b.

FIG. 9 shows the bait holder with hook 1 of FIG. 1, in a second state, and held by two hands 100 and 102, wherein the section 14 has now been opened to pry side walls 14a and 14b apart so that an opening 14c is created leading to inner chamber 2a, inside of body portion 2.

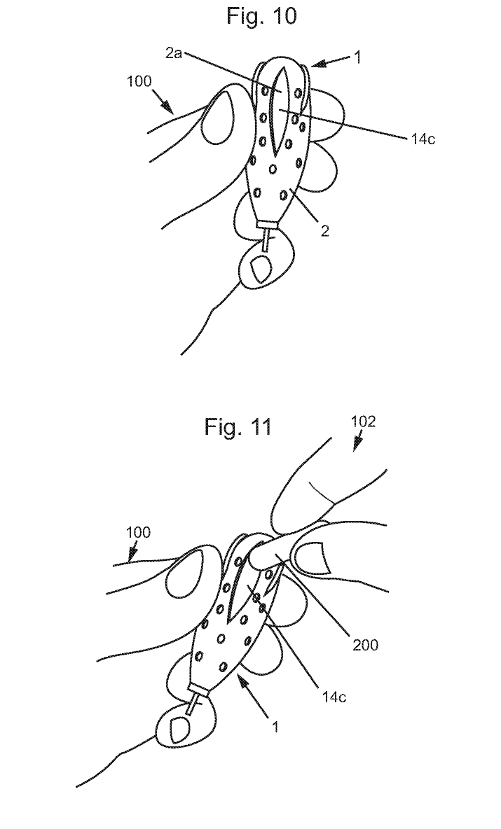

FIG. 10 shows the bait holder with hook 1 of FIG. 1, in the second state, and held by one hand 100, with the opening 14c shown leading to inner chamber 2a of the body portion 2.

FIG. 11 shows the bait holder with hook 1 of FIG. 1, in the second state, held by one hand 100, and with the second hand 102 shown inserting a piece of bait 200, such as a worm or small fish.

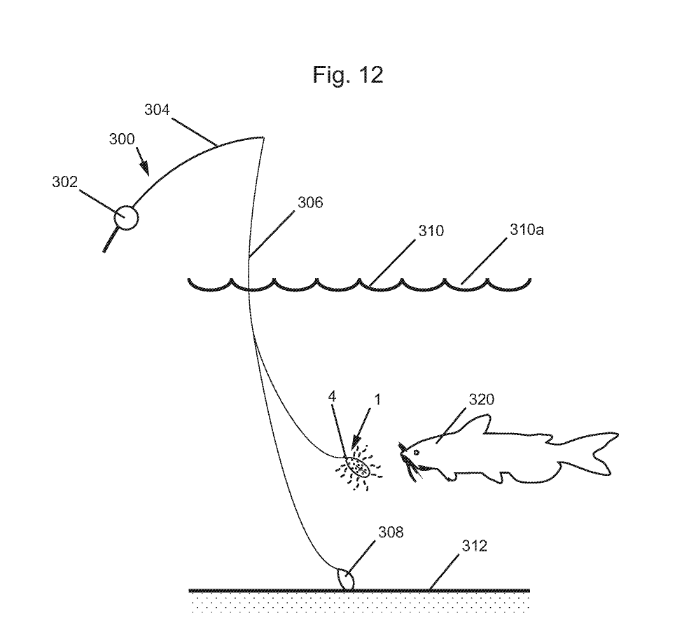

FIG. 12 shows the bait holder with hook 1 of FIG. 1 attached to a fishing line 306 of a fishing device 300, with the bait holder and hook 1 shown in a body of water 310, below the surface 310a, in which a fish 320 is swimming. There is a bottom surface, sea floor, or body of water floor 312. The fishing device 300 includes a reel, a pole, the line 306, a weight 308, and the bait holder with hook 1. The bait holder and hook 1 tied to line 306 through loop 4.

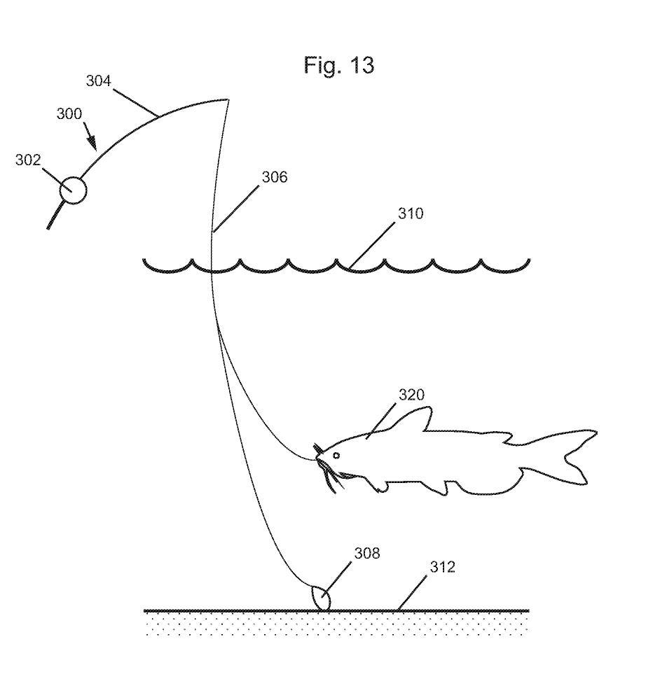

FIG. 13 shows the fishing line 306 of the fishing device 300, and the fish 320 of FIG. 12, after the bait holder and hook 1 has been swallowed by the fish 320 of FIG. 12.

In operation, the scent of the bait 200 within the inner chamber 2a of the body portion 2 of the bait holder and hook 1 escapes through the openings 8 so that the scent can be picked up by the fish 320.

The hooks 12 and 10 may be made of metal. The body portion 2 of the bait holder and hook 1 may be made a flexible elastic rubber, or other flexible elastic material such as silicone or a hybrid of silicone and rubber.

In at least one embodiment, the purpose of the holes or openings 8 is to let the smell of bait out as fish are attracted to the scent. The point of the body portion 2 shown in FIG. 1 is to keep tiny pan fish from ripping the bait apart and stealing the bait. The body portion 2 may be transparent to give the look of just the bait.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a body portion, having an inner chamber inside the body portion, wherein the body portion has a first end, and an opposing second end;
a loop located outside of the body portion, and connected to the body portion;
a plurality of holes in the body portion, which lead to the inner chamber; and
wherein the body portion has a region including a first wall and a second wall, wherein the first wall abuts against and is in contact with the second wall in a rest state, and wherein when a prying force is applied, the first wall can be separated from the second wall, so that there is a space between at least part of the first wall and at least part of the second wall, so that an item can be inserted through the space and into the inner chamber of the body portion.

2. The apparatus of claim 1 wherein
the body portion is made of rubber.

3. The apparatus of claim 1 further comprising
a first hook fixed to the body portion nearer the second end than the first end; and
and wherein the loop is located nearer the first end than the second end.

4. The apparatus of claim 3 further comprising
a second hook fixed to the body portion nearer the second end than the first end, and spaced apart from the first hook.

5. The apparatus of claim 1 wherein
the space is larger than any of the plurality of holes.

6. The apparatus of claim 1 wherein
the body portion is transparent.

7. A method comprising the steps of:
applying a prying force to a region of a body portion of an apparatus to create a space between a first wall of the body portion and a second wall of a body portion;
inserting fishing bait through the space and into an inner chamber of the apparatus;
wherein the apparatus is comprised of:
the body portion, having the inner chamber inside the body portion, wherein the body portion has a first end, and an opposing second end;
a loop located outside of the body portion, and connected to the body portion;
a plurality of holes in the body portion, which lead to the inner chamber.

8. The method of claim 7 further comprising
connecting the loop to a fishing line; and
casting the body portion into a body of water with the loop connected to a fishing line.

9. The method of claim 7 wherein
the body portion is made of rubber.

10. The method of claim 7 wherein
the apparatus includes a first hook fixed to the body portion nearer the second end than the first end; and
and wherein the loop is located nearer the first end than the second end.

11. The method of claim 10 further comprising
a second hook fixed to the body portion nearer the second end than the first end, and spaced apart from the first hook.

12. The method of claim 7 wherein
the space is larger than any of the plurality of holes.

13. The method of claim 7 wherein
the body portion is transparent.
